(19) United States
(12) Patent Application Publication
(10) Pub. No.: US 2011/0076472 A1
(43) Pub. Date: Mar. 31, 2011

(54) Package substrate

(76) Inventors: Jin Ho Kim, Gyunggi-do (KR); Seok Kyu Lee, Gyunggi-do (KR); Jae Joon Lee, Gyunggi-do (KR); Sung Won Jeong, Gyunggi-do (KR)

(21) Appl. No.: 12/655,516

(22) Filed: Dec. 30, 2009

(30) Foreign Application Priority Data
Sep. 29, 2009 (KR) 10-2009-0092535
Dec. 24, 2009 (KR) 10-2009-0130922

(51) Int. Cl. B32B 7/02

(52) U.S. Cl. 428/213

(57) ABSTRACT

Disclosed is a package substrate, in which the plating area of a first plating layer formed on a layer which is to be connected to a motherboard is larger than the plating area of a second plating layer formed on a layer which is to be connected to an electronic part, and the plating thickness of the second plating layer is greater than the plating thickness of the first plating layer, thus balancing the plating volumes of the plating layers formed on the layers of the package substrate, thereby minimizing warpage of the package substrate which results from the coefficients of thermal expansion being different.

### CROSS REFERENCE TO RELATED APPLICATION

This application claims the benefit of Korean Patent Application No. 10-2009-0092535, filed Sep. 29, 2009, entitled “A package substrate”, and Korean Patent Application No. 10-2009-0130922, filed Dec. 24, 2009, entitled “A package substrate”, which are hereby incorporated by reference in its entirety into this application.

### BACKGROUND OF THE INVENTION

1. Technical Field

The present invention relates to a package substrate.

2. Description of the Related Art

As electronic apparatuses are being manufactured to have increased performance and a smaller size, the number of terminals of an electronic part such as a semiconductor chip, a die and so on is remarkably increasing. In order to easily mount such an electronic part on a motherboard, a package substrate which is adapted for the electrical connection between the electronic part and the motherboard is also being made thinner.

Accordingly, a coreless structure which improves signal transmission properties and enables the thickness to be reduced by removing a core substrate is most often employed in a package substrate.

FIG. 1 is a cross-sectional view showing a conventional package substrate having a coreless structure. The package substrate of FIG. 1 illustratively has an eight-layer structure.

As shown in FIG. 1, the conventional package substrate has a multilayer coreless structure composed of an insulating layer 300 and negative and positive plating layers 100, 200 formed thereon. Also, first to fourth layers 1L, 2L, 3L, 4L constitute a lower layer Lb which will be mounted on a motherboard, and are configured such that a lower plating layer 100 is formed on the insulating layer 300. Also, fifth to eighth layers 5L, 6L, 7L, 8L constitute an upper layer Lu on which an electronic part will be mounted, and are configured such that an upper plating layer 200 is formed on the insulating layer 300. Further, in order to protect the outermost circuit layer from the external environment, a lower solder resist layer 400a is formed on the lower surface of the first layer 1L, an upper solder resist layer 400b is formed on the upper surface of the eighth layer 8L, and also, a bump 500 for mounting an electronic part is formed on the outermost upper plating layer 200d.

However, the conventional package substrate having a coreless structure has weaker strength compared to a structure using a core substrate, and thus it may easily warp. Such warpage occurs because layers of the package substrate use materials having different mechanical properties and have different coefficients of thermal expansion and thus exhibit different thermal behaviors concerning heat hysteresis in a reflow process.

In order to solve this problem, conventional attempts to insert an additional reinforcing plate, to form an additional dummy pattern on a dummy region or to control the thickness or open area of a solder resist layer have been made. Such attempts have been proven to be effective to some degree, but there is a need to reluctantly perform the actions of using an additional member or performing an additional process. In particular, in a case where the reinforcing plate is inserted, the thickness of the package substrate is undesirably increased.

Table 1 below shows the plating area per layer of the package substrate of FIG. 1 and the plating area ratio. As is apparent from Table 1 below, the plating area of the lower layer Lb is larger than that of the upper layer Lu. Typically, the lower layer Lb of the package substrate performs a grounding function, and the upper layer Lu, on which is a region for mounting the electronic part, has a fine pattern structure, thus inevitably causing the areas of the plating areas to be different. Furthermore, because the plating thickness Tu of the upper plating layer 200 is equal to the plating thickness Tb of the lower plating layer 100, the plating volume of the lower plating layer 100 having a larger plating area is naturally greater than the plating volume of the upper plating layer 200.

TABLE 1

| Layer | Plating Area (%) | Plating Area Ratio |
|---|---|---|
| 8L | 68.55 | 77.95 |
| 7L | 75.70 | |
| 6L | 85.50 | |
| 5L | 82.05 | |
| 4L | 88.80 | 86.15 |
| 3L | 88.20 | |
| 2L | 85.30 | |
| 1L | 82.30 | |

In the case where the plating volumes of the lower plating layer 100 and the upper plating layer 200 are different as mentioned above, differences in the coefficients of thermal expansion between the upper layer Lu and the lower layer Lb necessarily occur, and undesirably make up the major contributor to warping of the package substrate.

Conventionally, with the exclusion of the plating amount deviations of the plating layers 100, 200 which are the major constituent of the package substrate, attempts to insert an additional reinforcing plate or to adjust the thickness of a solder resist layer so as to prevent warpage of the package substrate have been made. But these attempts merely indirectly prevent warpage through reinforcing predetermined portions of the substrate.

Therefore, there are urgently required alternatives for preventing warpage of the package substrate unavoidably resulting from deviations in the plating amount (plating volume) of the lower plating layer 100 and the upper plating layer 200.

### SUMMARY OF THE INVENTION

Accordingly, the present invention has been made keeping in mind the problems encountered in the related art and the present invention is intended to provide a package substrate in which the plating volumes of plating layers formed on layers of the package substrate are balanced, so that warpage due to differences in the coefficients of thermal expansion of the plating layers are able to be minimized.

An aspect of the present invention provides a package substrate, wherein a first plating layer formed on a layer which is to be connected to a motherboard has a plating area larger than a plating area of a second plating layer formed on a layer which is to be connected to an electronic part, and a plating thickness of the second plating layer is greater than a plating thickness of the first plating layer.

In this aspect, the plating thickness of the first plating layer may be the mean plating thickness of an entire first plating layer of the layer which is to be connected to the motherboard, and the plating thickness of the second plating layer may be the mean plating thickness of an entire second plating layer of the layer which is to be connected to the electronic part.

In this aspect, the plating thickness per layer of the second plating layer located on one side of a neutral plane of the package substrate may be greater than the plating thickness per layer of the first plating layer symmetrically located on the other side of the neutral plane of the package substrate.

In this aspect, the plating thickness of the second plating layer may be greater by 1˜5 μm than the plating thickness of the first plating layer.

In this aspect, when the plating area ratio of the second plating layer and the first plating layer falls in a range of 1:1.01˜1:1.3, the plating thickness ratio of the second plating layer and the first plating layer falls in a range of 1.1:1˜1.5:1.

In this aspect, a second plating layer formed on an outermost layer which is to be connected to the electronic part may have a plating thickness greater than that of a first plating layer formed on an outermost layer which is to be connected to the motherboard.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The features and advantages of the present invention will be more clearly understood from the following detailed description taken in conjunction with the accompanying drawings, in which:

FIG. 1 is a cross-sectional view showing a conventional package substrate having a coreless structure;

FIG. 2 is a schematic cross-sectional view showing a package substrate according to an embodiment of the present invention;

FIG. 3 is a cross-sectional view showing a package substrate having a six-layer structure;

FIGS. 4A and 4B are views showing the warped state of the package substrate of FIG. 3 at different plating thicknesses;

FIG. 5 is a graph showing the sensitivity to warping of the package substrate of FIG. 3 depending on changes in the plating thickness per layer; and

FIGS. 6 and 7 are schematic cross-sectional views showing examples of a package substrate according to another embodiment of the present invention.

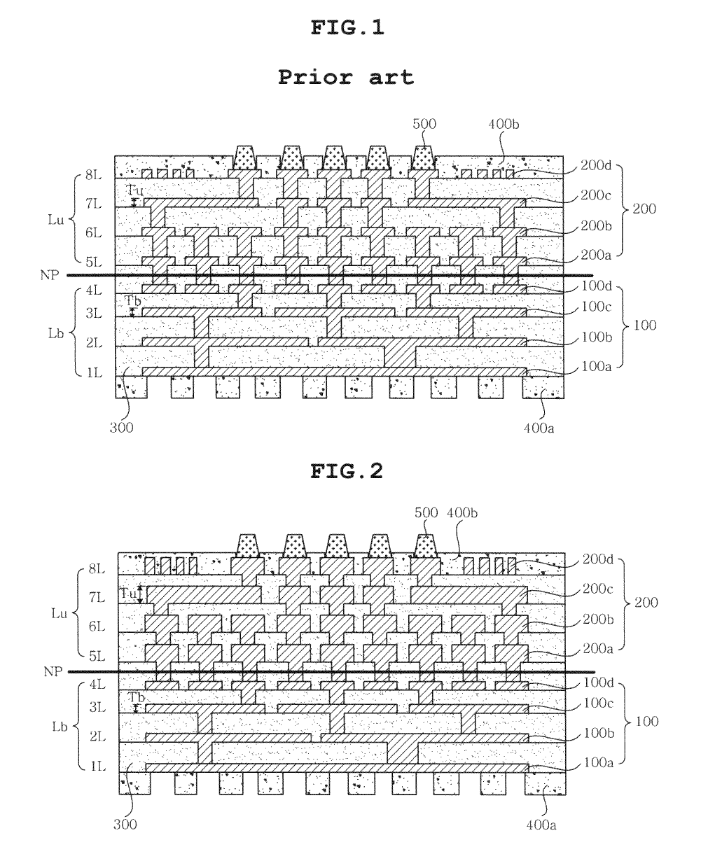

### DESCRIPTION OF SPECIFIC EMBODIMENTS

Hereinafter, embodiments of the present invention will be described in detail while referring to the accompanying drawings. In the description, the terms “first”, “second” and so on are used not to show a certain amount, sequence or importance but to distinguish one element from another element, and the elements are not being defined by the above terms. Throughout the drawings, the same reference numerals refer to the same or similar elements. Furthermore, descriptions of known techniques, even if they are pertinent to the present invention, are regarded as unnecessary and may be omitted in so far as they would make the characteristics of the invention unclear and muddy the description.

Furthermore, the terms and words used in the present specification and claims should not be interpreted as being limited to typical meanings or dictionary definitions, but should be interpreted as having those meanings and concepts relevant to the technical scope of the present invention based on the rule according to which an inventor can appropriately define the concept implied by the term to best describe the method he or she knows for carrying out the invention.

FIG. 2 is a schematic cross-sectional view showing a package substrate according to an embodiment of the present invention. Although FIG. 2 illustrates a package substrate having an eight-layer structure, any package substrate having a multilayer structure may be provided, and this should be incorporated into the scope of the present invention. Below, the package substrate according to the present embodiment is described with reference to the above drawing.

As shown in FIG. 2, the package substrate according to the present embodiment is configured such that the plating area of a first plating layer 100 formed on a layer Lb which will be connected to a motherboard is larger than the plating area of a second plating layer 200 formed on a layer Lu which will be connected to an electronic part, and the plating thickness Tu of the second plating layer 200 is greater than the plating thickness Tb of the first plating layer 100.

Herein, the plating thicknesses Tb, Tu may be a plating thickness of the first and second plating layers 100, 200 at specific standard positions, but desirably are the mean plating thickness in order to propose a structure for preventing the package substrate from warping which takes into consideration the net plating volume of the package substrate. For example, the plating thickness Tb of the first plating layer 100 indicates the mean plating thickness of the entire first plating layer 100 of the layer Lb including the first to fourth layers 1L, 2L, 3L, 4L, and the plating thickness Tu of the second plating layer 200 indicates the mean plating thickness of the entire second plating layer 200 of the layer Lu including the fifth to eighth layers 5L, 6L, 7L, 8L. In the present embodiment, the mean plating thickness of the entire second plating layer 200 is greater than the mean plating thickness of the entire first plating layer 100.

When the plating thickness Tu of the second plating layer is greater than the plating thickness Tb of the first plating layer as mentioned above, the plating volumes of the second plating layer 200 and the first plating layer 100 may be balanced at the same level, so that the coefficients of thermal expansion of the second plating layer 200 and the first plating layer 100 are maintained uniform, thereby minimizing warpage of the package substrate. Specifically, in the present invention, the plating volume deviations resulting from the inevitable plating area deviations between the layer Lu which mounts an electronic part and the layer Lb which is mounted on a motherboard may be overcome by applying the inverse of such deviations to the plating thickness. Because the plating thickness deviations may be simply controlled by changing the plating conditions during the course of plating the first plating layer 100 and the second plating layer 200, mass manufacturing of the package substrate according to the present invention is in practice considerably productive.

The plating thickness Tu per layer of the second plating layer 200 located on one side of a neutral plane (NP) of the package substrate is set to be greater than the plating thickness Tb per layer of the first plating layer 100 symmetrically located on the other side of the neutral plane of the package substrate. Specifically, the plating thickness of the second plating layer 200a formed on the fifth layer 5L is greater than the plating thickness of the first plating layer 100d formed on the fourth layer 4L, and the plating thickness of the second plating layer 200b formed on the sixth layer 6L is greater than the plating thickness of the first plating layer 100c formed on the third layer 3L. Furthermore, the plating thickness of the second plating layer 200c formed on the seventh layer 7L is greater than the plating thickness of the first plating layer 100b formed on the second layer 2L, and the plating thickness of the second plating layer 200d formed on the eighth layer 8L is greater than the plating thickness of the first plating layer 100a formed on the first layer 1L.

In this way, the plating thicknesses Tb, Tu of the first plating layer 100 and the second plating layer 200 formed on the symmetrically arranged layers are adjusted, thereby reducing the plating volume deviations of the layers. Thus, warpage which occurs due to plating volume deviations of the layers even when the net plating volume is the same may be minimized.

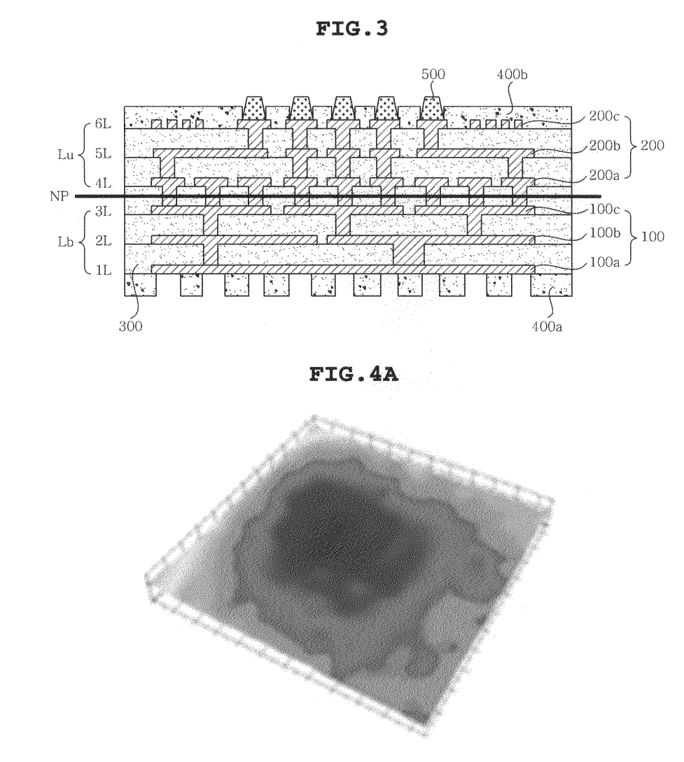

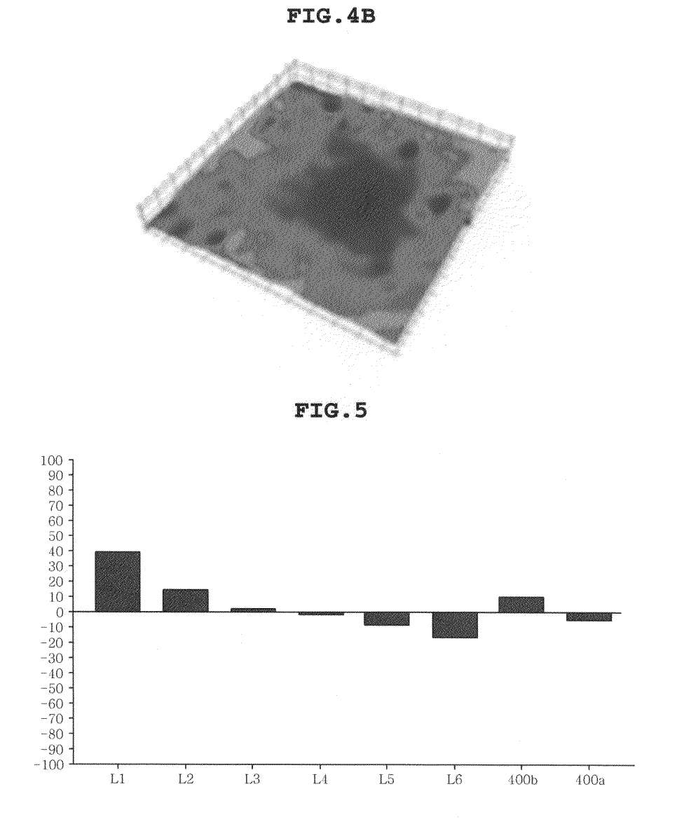

FIGS. 3 and 4A and 4B show a package substrate and its warped state which is dependant on changes in plating thickness per layer. Specifically, FIG. 3 illustrates a cross-sectional view showing a package substrate having a six-layer structure, and FIGS. 4A and 4B show the warped state of the package substrate of FIG. 3 at different plating thicknesses. The plating thickness per layer of the package substrate of FIG. 3 is given in Table 2 below.

TABLE 2

| Layer | Plating Thickness (μm) |
|---|---|
| 1L | X |
| 2L | 14.96 |
| 3L | 15.89 |
| 4L | 15.56 |
| 5L | 15.54 |
| 6L | 16.54 |

The warpage of the package substrate of FIG. 3 resulting from changing the plating thickness X of the first layer 1L is measured. When X=14.3, the results shown in FIG. 4A may be obtained, and also, when X=17.9, the results shown in FIG. 4B may be obtained. In the drawings, the yellow portion represents a high degree of warpage, and the blue portion represents a low degree of warpage. Specifically, when the plating thickness of the first layer 1L is greater than the plating thickness of the fourth to sixth layers 4L, 5L, 6L, the package substrate can be seen to warp less, compared to when the plating thickness of the first layer 1L is smaller than the plating thickness of the fourth to sixth layers 4L, 5L, 6L.

As a result of such measurement, when the plating thickness of the second plating layer 200 is greater by about 1˜5 μm, in particular, about 3˜5 μm than the plating thickness of the first plating layer 100, the package substrate can be seen to warp much less. Furthermore, when the plating area ratio of the second plating layer 200 and the first plating layer 100 falls in the range of 1:1.01˜1:1.3, the package substrate warps much less in the plating thickness ratio range of the second plating layer 200 and the first plating layer 100 of 1.1:1˜1.5:1.

FIG. 5 is a graph showing the sensitivity to warping of the package substrate of FIG. 3 depending on changes in plating thickness per layer.

As shown in FIG. 5, the warpage of the package substrate can be seen to sensitively change depending on changes in plating thickness of the plating layer formed on an outermost layer of the package substrate. Thus, as occasion demands, warping of the package substrate may be minimized only through adjusting the thickness of the outermost plating layer. Specifically, when the plating thickness of the outermost second plating layer 200 is greater than the plating thickness of the outermost fist plating layer 100, warping of the package substrate may be minimized. That is, the plating thickness of the second plating layer 200c formed on the sixth layer 6L is greater than the plating thickness of the first plating layer 100a formed on the first layer 1L.

As is apparent from FIG. 5, warping of the package substrate can be seen to change with greater sensitivity depending on changes made to the plating thickness of the outermost plating layer rather than for changes made to the thicknesses of the lower solder resist layer 400a and the upper solder resist layer 400b. Conventionally, many attempts have been made to change the thickness of the solder resist layer so as to reduce the warping of the package substrate. However, as shown in FIG. 5, limitations may be imposed on reducing the warping of the package substrate without changing the plating thickness of the plating layer. Furthermore, the changes in the plating thickness of the plating layer as well as in the thickness of the solder resist layer may obviously result in reduced warpage of the package substrate.

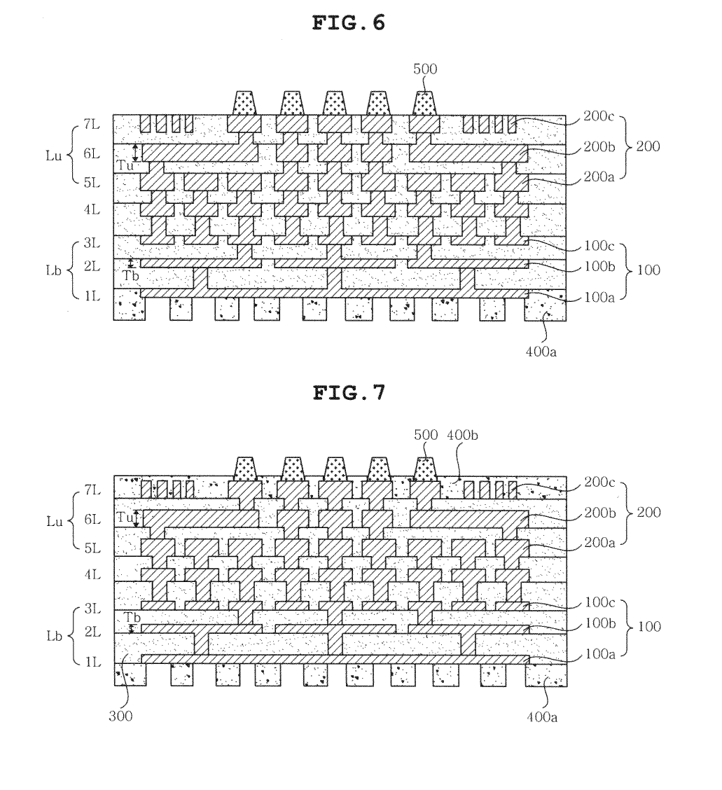

FIGS. 6 and 7 are schematic cross-sectional views showing examples of a package substrate according to another embodiment of the present invention.

The package substrate of FIG. 6 is different from the package substrate of FIG. 7 in terms of the direction of formation of the via and whether the outermost circuit layer (200c or 100a) is buried. Also, the package substrate according to the present embodiment may have a seven-layer structure. That is, the package substrate according to the present embodiment has an odd-layer structure unlike the aforementioned package substrate (which has an eight- or six-layer structure). Thus, a first plating layer 100 is formed on first to third layers 1L, 2L, 3L, and a second plating layer 200 is formed on fifth to seventh layers 5L, 6L, 7L. As such, in order to maintain the balance of coefficients of thermal expansion between the first plating layer 100 and the second plating layer 200, it is desirable that the fourth layer 4L belong to neither the first plating layer 100 nor the second plating layer 200.

Also, as mentioned above, the plating thickness Tb of the first plating layer 100 is the mean plating thickness of the entire first plating layer 100 formed on the first to third layers 1L, 2L, 3L, and the plating thickness Tu of the second plating layer 200 is the mean plating thickness of the entire second plating layer 200 formed on the fifth to seventh layers 5L, 6L, 7L. Moreover, in the present embodiment, the mean plating thickness of the entire second plating layer 200 is set to be greater than the mean plating thickness of the entire first plating layer 100.

The plating thickness per layer of the second plating layer 200 located on one side of the fourth layer 4L functioning as a neutral plane of the package substrate according to the present embodiment may be greater than the plating thickness per layer of the first plating layer 100 symmetrically located on the other side of the fourth layer 4L of the package substrate. Specifically, the plating thickness of the second plating layer 200 formed on the fifth layer 5L is greater than the plating thickness of the first plating layer 100 formed on the third layer 3L, and the plating thickness of the second plating layer 200 formed on the sixth layer 6L is greater than the plating thickness of the first plating layer 100 formed on the second layer 2L. Furthermore, the plating thickness of the second plating layer 200 formed on the seventh layer 7L is greater than the plating thickness of the first plating layer 100 formed on the first layer 1L.

As described hereinbefore, the present invention provides a package substrate. In the package substrate according to the present invention, the plating thickness of a second plating layer which will be connected to an electronic part is greater than the plating thickness of a first plating layer which will be connected to a motherboard, so that the plating volumes of the second plating layer and the first plating layers can be balanced. Thus, a difference in the coefficients of thermal expansion resulting from plating volume deviations of the plating layers formed on layers of the package substrate can be eliminated, thereby minimizing warping of the package substrate.

Also, according to the present invention, the plating thickness of the second plating layer formed on each of the layers of the package substrate is controlled to be greater than the plating thickness of the first plating layer arranged symmetrically thereto, thereby reducing the plating volume deviations of the layers. Hence, warping of the package substrate due to plating volume deviations of the layers thereof can be minimized.

Also, according to the present invention, there is proposed a package substrate structure able to minimize the warpage of the package substrate by adjusting the thickness of the outermost plating layer because the volume of the outermost plating layer greatly affects the warpage of the package substrate.

Although the embodiments of the present invention regarding the package substrate have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A package substrate, wherein a first plating layer formed on a layer which is to be connected to a motherboard has a plating area larger than a plating area of a second plating layer formed on a layer which is to be connected to an electronic part, and a plating thickness of the second plating layer is greater than a plating thickness of the first plating layer.

2. The package substrate as set forth in claim 1, wherein the plating thickness of the first plating layer is a mean plating thickness of an entire first plating layer of the layer which is to be connected to the motherboard, and the plating thickness of the second plating layer is a mean plating thickness of an entire second plating layer of the layer which is to be connected to the electronic part.

3. The package substrate as set forth in claim 1, wherein the plating thickness per layer of the second plating layer located on one side of a neutral plane of the package substrate is greater than the plating thickness per layer of the first plating layer symmetrically located on the other side of the neutral plane of the package substrate.

4. The package substrate as set forth in claim 1, wherein the plating thickness of the second plating layer is greater by 1˜5 μm than the plating thickness of the first plating layer.

5. The package substrate as set forth in claim 1, wherein, when a plating area ratio of the second plating layer and the first plating layer falls in a range of 1:1.01˜1:1.3, a plating thickness ratio of the second plating layer and the first plating layer falls in a range of 1.1:1˜1.5:1.

6. The package substrate as set forth in claim 1, wherein a second plating layer formed on an outermost layer which is to be connected to the electronic part has a plating thickness greater than that of a first plating layer formed on an outermost layer which is to be connected to the motherboard.
